(19) United States
(12) Patent Application Publication
(10) Pub. No.: US 2005/0117339 A1
(43) Pub. Date: Jun. 2, 2005

(54) Illuminating light string arrangement

(76) Inventor: Frank Pan, Rosemead, CA (US)

Correspondence Address: DAVID AND RAYMOND PATENT GROUP, 1050 OAKDALE LANE, ARCADIA, CA, 91006, US

(21) Appl. No.: 10/998,093

(22) Filed: Nov. 24, 2004

Related U.S. Application Data
(60) Provisional application No. 60/525,663, filed on Dec. 1, 2003.

(51) Int. Cl. F21V 21/00

(52) U.S. Cl. 362/249; 362/391

(57) ABSTRACT

An illuminating light string arrangement includes a plurality of illuminating units, each of which includes a light housing, a conductive element disposed in the light housing, and an illuminator supported on the light housing to electrically connect with the conductive element; a plurality of flexible connecting links extending between the two conductive elements of two illuminating units respectively in such a manner that each of the two illuminating units are electrically linked through the respective connecting link so as to link up the illuminating units in sequence to form a light string; and a control unit, which is arranged to direct a direct current to the light string.

### CROSS-REFERENCE TO RELATED APPLICATION

This is a regular application of a provisional application having an application No. 60/525,663 and a filing date of Dec. 01, 2003.

### BACKGROUND OF THE PRESENT INVENTION

1. Field of Invention

The present invention relates to light, and more particularly to an illuminating light string arrangement which has an enhanced versatility, durability, flexibility, and functionality as compared with conventional arts.

2. Description of Related Arts

Conventional rope lights and light strings are widely utilized in that they provide impressive decoration to a wide variety of situations, such as for domestic decoration during Christmas or Easter, or for decoration of shops, offices and restaurants in order to attract business.

A conventional light string usually comprises a plurality of illumination devices, such as regular light bulbs, which are electrically connected with each other via a connecting wire, and a power inlet, such as a electric power plug, provided at the end of the connecting wire and adapted for connecting to an external power source, such as a regular AC power source.

With respect to such conventional light string, several obvious and deep-seated disadvantages can be readily identified. First of all, it is obvious that the regular light bulbs are liable to damage very easily. They are extremely fragile so that once they are broken, it may even cause harm to somebody else who accidentally in touch with the broken bulb.

Second, very often, the illuminating devices of the conventional light string are electrically connected in series. As a result, subject to the above-mentioned disadvantage, once any one of the illuminating devices is broken, the electric supply to the other intact illuminating devices will be immediately terminated. Unless the broken light bulb is replaced, it is no other option for the light string to illuminate again.

Third, since the illuminating devices are very fragile, this poses difficulty in storing and transporting the light string. Especially when the light string is used in an outdoors environment, it needs to be tangled and transported by car, and during the course of the transportation, the vibration of the car may cause damage to the illuminating devices. Moreover, when the light string is severely tangled, it is difficult to untangle without damaging some of the illuminating devices. Finally, when the conventional light string is used for a prolonged period of time, a substantial amount of heat may generated by the illuminating devices, thus risking its user or any people passing by.

Despite these disadvantages, the conventional light string has an inherent advantage wherein each of the illuminating devices is usually small in size. Thus, when it is used as a decorative instrument, it not only provides a fancy decoration for the user, but also minimizes its interference with other objects. Thus, conventional light strings are generally welcomed by public, despite their disadvantages.

On the other hand, conventional rope lights have been developed to partly overcome the disadvantages of conventional light strings. A conventional rope light usually comprises a hollow protective tube and a lighting chain comprising a plurality of illuminating devices electrically together to provide illumination wherein the lighting chain is received in the protective tube which is usually light transmissible so that light generated from the illuminating devices are capable of reaching outside the rope light through the protective tube.

One advantage of such conventional rope light is that the illuminating devices are well protected from physical damages by other objects. However, such protection takes the cost of more bulky structure of the whole rope light and deteriorated flexibility in their practical utilization. Moreover, because the protective tube is usually made of rigid materials such as plastic having a sound strength, the rope light is usually heavier than the light string.

From the foregoing analysis, one can appreciate that both the conventional light string and the conventional rope light are far less then satisfactory, and need further development.

### SUMMARY OF THE PRESENT INVENTION

A main object of the present invention is to provide an illuminating light string arrangement which has an enhanced flexibility as well as damage resistibility in utilization as compared with conventional light string and rope light.

Another object of the present invention is to provide an illuminating light string arrangement which comprises a plurality of illuminating units which are capable of withstanding a considerable impact during a normal course of operation and transportation and storage so that they are prevented from being easily damaged.

Another object of the present invention is to provide an illuminating light string arrangement which is flexible enough to form a wide variety of shapes without having the problem of difficult untangling and easy damaging of the illuminating units. In other words, the present invention significantly resolves the inherent disadvantages of conventional light strings and rope lights at the same time.

Another object of the present invention is to provide an illuminating light string arrangement which comprises a plurality of illuminating units which can be easily replaceable by a user of the present invention.

Another object of the present invention is to provide an illuminating light string arrangement which does not involve fragile illuminating units and bulky-sized protective tube so that it can be conveniently untangled from storage without having risk of damaging the illumination units.

Another object of the present invention is to provide an illuminating light string arrangement wherein the illuminating units do not generate a large amount of heat so as to prevent harm to the user or the people passing by.

Another object of the present invention is to provide an illuminating light string arrangement which is adapted to be customary extendable so as to fit different situations in which the present invention is utilized.

Another object of the present invention is to provide an illuminating light string arrangement which does not involve complicated mechanical or electrical components or connections so as to minimize the manufacturing cost and the ultimate selling price of the present invention.

Accordingly, in order to accomplish the above objects, the present invention provides an illuminating light string arrangement, comprising:
a plurality of illuminating units, each of which comprises a light housing, a conductive element disposed in the light housing, and an illuminator supported on the light housing to electrically connect with the conductive element;
a plurality of flexible connecting links, each having two conductive ends electrically extended between the two conductive elements of two illuminating units respectively in such a manner that each of the two illuminating units are electrically linked through the respective connecting link so as to link up the illuminating units in sequence to form a light string; and
a control unit, which is arranged to direct a direct current to the light string, and comprises a circuit controlling the illuminating units so as to activate the illuminating units to produce a light effect.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an illuminating light string arrangement according to a preferred embodiment of the present invention.

FIG. 2 is a side view of the illuminating unit according to the above preferred embodiment of the present invention.

FIG. 3 is a schematic diagram of the illuminating light string arrangement according to the above preferred embodiment of the present invention, illustrating the electrical connection between the illuminating units.

FIG. 4 is an alternative mode of the illuminating light string arrangement according to the preferred embodiment of the present invention.

FIG. 5 is a side view of the light housing of the illuminating light string arrangement according to the alternative mode of the present invention.

FIG. 6 is a partial perspective view of the illuminating light string arrangement according to the above preferred embodiment of the present invention.

### DETAILED DESCRIPTION OF THE PREFERRED EMBODIMENT

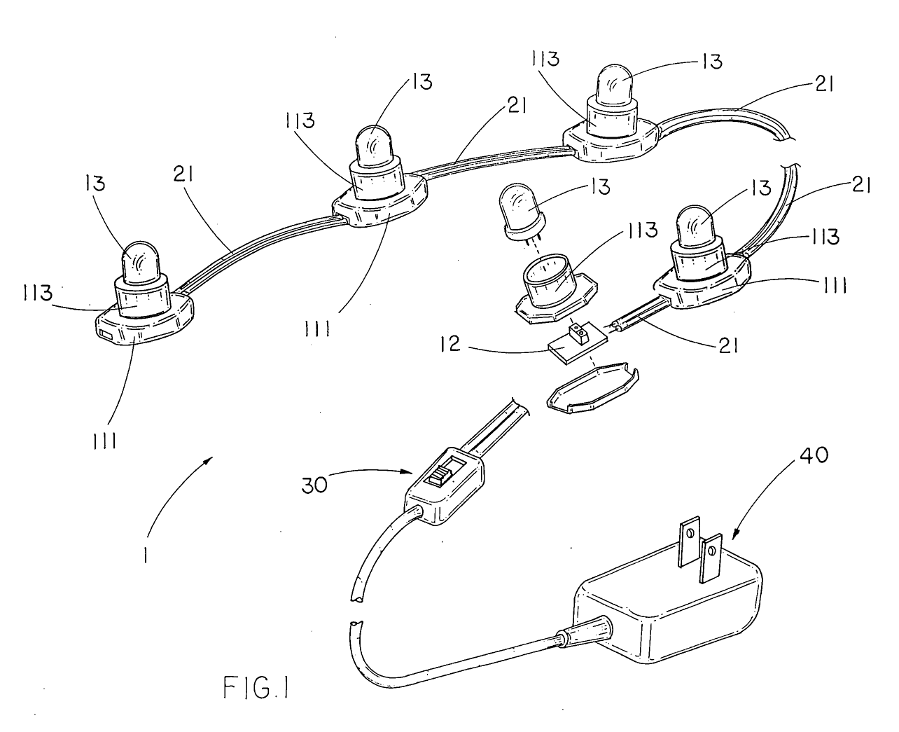

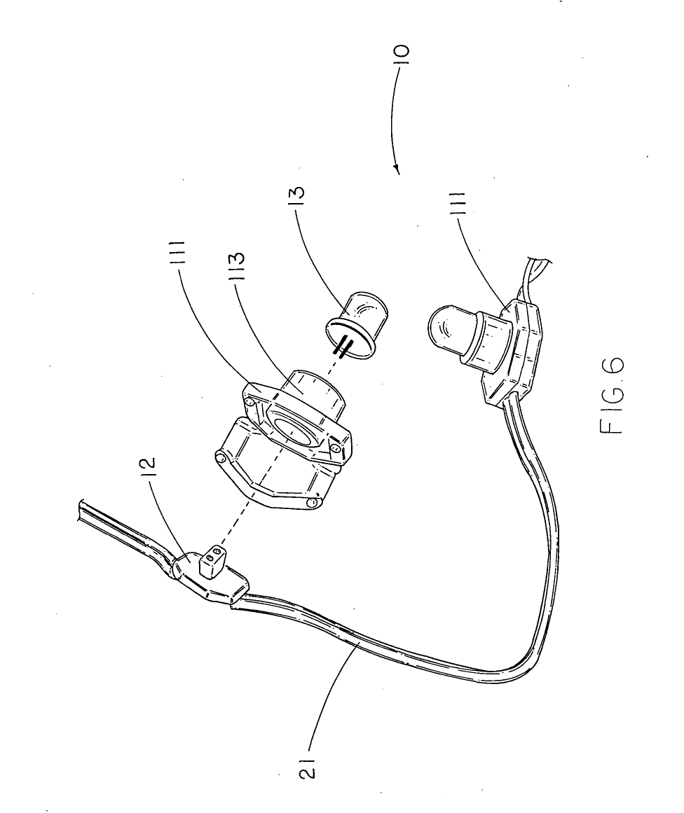

Referring to FIG. 1 and FIG. 6 of the drawings, an illuminating light string arrangement 1 according to a preferred embodiment of the present invention is illustrated, in which the illuminating light string arrangement 1 comprises a plurality of illuminating units 10, a plurality of flexible connecting links 20, and a control unit 30.

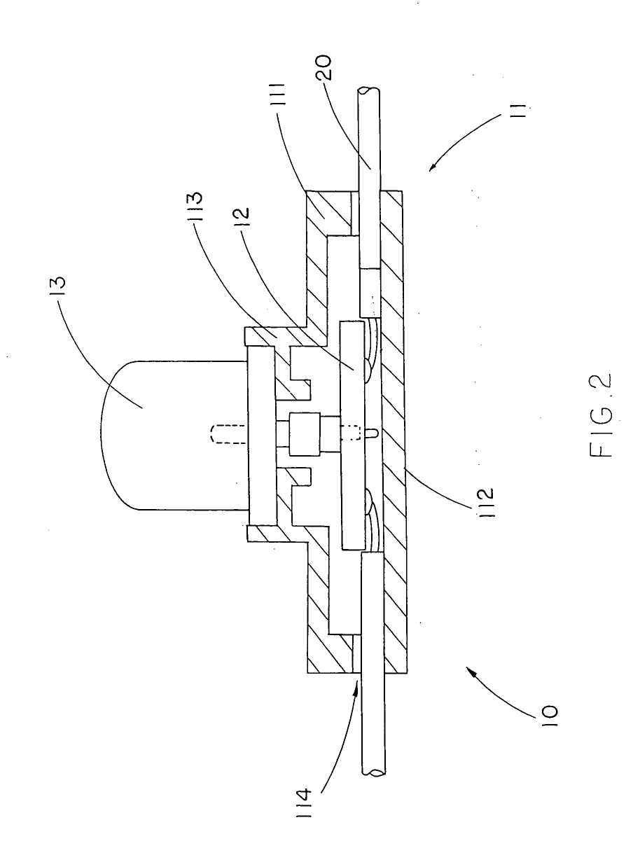

Referring to FIG. 1 to FIG. 2 of the drawings, each of the illuminating units 10 comprises a light housing 11, a conductive element 12 disposed in the light housing 11, and an illuminator 13 supported on the light housing 11 and electrically connected with the conductive element 12.

The light housing 11 comprises a base 111 having a bottom attaching surface 112 formed thereon which is adapted for attaching to an external object, such as a wall surface, and an illuminator holder 113 extended above the base 111 for receiving the illuminator 13 which is electrically connected with the conductive element 12 disposed in the light housing 11.

The illuminator 13 is preferably embodied as a Light Emitting Diode (LED) having a durable light cover which is capable of sustaining a predetermined impact during the normal course of its operation, storage and transportation. Moreover, a positive and a negative terminal are downwardly extended to electrically connect with the conductive element 12 in such a manner that an electric current will be allowed pass through the illuminator 13 through the conductive element 12. Preferably, the durable light cover is made of rigid and strong materials, i.e. non-fragile materials, such as polyvinyl chloride (PVC) plastic to provide enhanced impact resistibility as compared with conventional light strings.

In addition, since the illuminators 13 are embodied as LEDs, which do not generate significant heat during their operation, the illuminating light string arrangement 1 of the present invention is then free from originating heat which may be harmful to the user or a person passing by, as opposed to conventional light strings.

Furthermore, the LEDs utilized in the present invention are embodied as having such small sizes that the user can be able to easily untangle the light string after storage. The durable light cover of each of the illuminators 13 prevent them from being accidentally destroyed as a result of possible collision between each other.

Each of the flexible connecting links 20 has two conduction ends electrically extended between the two conductive elements 12 of each two illuminating units 10 respectively, in such a manner that each of the two illuminating units 10 are electrically linked through the respective flexible connecting link 20 so as to link up all the illuminating units 10 in sequence to form a light string to provide illumination.

According to the preferred embodiment, each of the flexible connecting link 20 comprises a flat cable 21 longitudinally extended between each two illuminating units 10 wherein electrical wires are received in the flat cable for electrically connecting the two conductive element 12 of each of the illuminating units 10. Moreover this flat cable minimizes the manufacturing procedures required and promotes automation for the fabrication of the connecting link 20 so that the manufacturing cost of the present invention can be minimized accordingly. The connecting link 20 should be made of flexible materials, such as plastic, so as it can be deformed to form a wide variety of shapes fitting different surrounding circumstances.

Furthermore, each of the light housing 11 has two engaging slots 114 formed on two side of the attaching base 111 to communicate with a cavity of the light housing 11 wherein the connecting links 20 are electrically connected between each two illuminating units 10 through the respective engaging slots 114. In other words, each conducting end of each of the flexible connecting link 20 is arranged to be biased and retained by the respective engaging slot 114 of the respective light housing 11.

The control unit 30 is arranged to direct a Direct Current (DC) to the light string so as to activate the illuminators 13 to generate light through the respective conductive element 12. Furthermore, the control unit 30 comprises a command circuit 31 which is electrically connected to the light string for electrically controlling the manner in which the illuminators 13 illuminate.

It is worth mentioning that each of the conductive elements 12 can be embodied as an operating circuit received in the light housing 11 and electrically connecting each two flexible connecting link 20 and the respective illuminator 13. The operating circuit is arranged to direct a predetermined electric current to the illuminator 13 for lighting up the illuminator 13. The manner in which the illuminators 13 illuminate, such as blinking or flashing, is therefore regulated and controlled by the command circuit 31 electrically connected with the light string outside any one particular light housing 11.

Or, alternatively, the manner in which each illuminator 13 illuminates can be electronically controlled by the respective operating circuit so that each of the illuminators 13 can have different but predetermined light effect as dictated by the respective operating circuit. Then, the command circuit 31 can be utilized as regulating electrical power which is to be delivered to the individual illuminating units 10.

On the other hand, the control unit 30 further comprises a control panel 32 electrically connected with the command circuit 31 wherein a user is allows to control the light effect of the light string by inputting command to the command circuit 31.

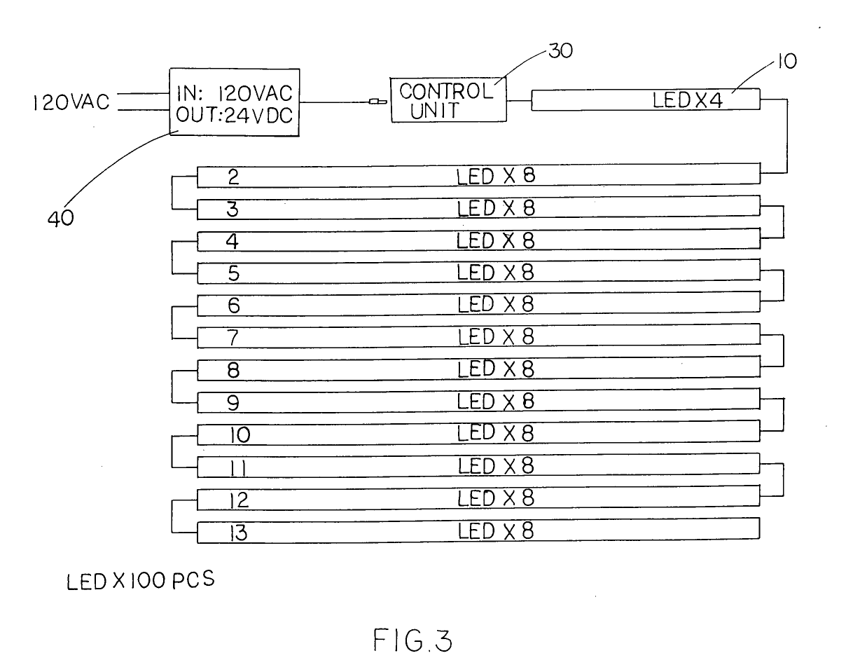

Referring to FIG. 3A of the drawings, the illuminating light string arrangement 1 further comprises a power device 40 which is extended from the light string to electrically connect with an external power source. The power device is preferably embodied as a regular AC-DC transformer electrically connecting between the light string and a regular AC power supply so as to convert AC power to DC and supply the DC to the control unit 30 for use by the illuminators 13 of the illuminating units 10.

It is worth pointing out that the illuminators 13 in this preferred embodiment has comparatively low power consumption than conventional light stings which utilize regular bulbs. As an illustration, the following table (table 1) tabulates a comparison of power consumption of a regular light strings and the illuminating light string arrangement of the present invention:

TABLE 1

| | Conventional | Illuminating |
|---|---|---|
| | Christmas | light string |
| | light string | arrangement 1 |
| Quantity estimated | 1 set | 1 set |
| Number of illuminators | 100 | 100 |
| utilized | | |
| Estimated power | 40 | 5 |
| consumption (W/hr.) | | |
| Power consumption/day | 40 w × 24 hr. = | 5 w × 24 hr. = |
| | 960 wh | 120 wh |
| Power consumption/year | 960 wh × 365 = | 120 wh × 365 = |
| | 350.4 kwh | 43.8 kwh |
| National average electric | $42.05 | $5.26 |
| cost/year (an estimate rate | | |
| of $0.12/kwh) | | |

| | |
|---|---|
| Cost comparison | $42.05 − $5.26 = $36.76 |

Referring to FIG. 3 of the drawings, the electrical connection between the illuminating units 10 is as follows: suppose there are altogether one hundred illuminators received in on hundred illuminating units 10 respectively, that one hundred illuminating units 10 are then divided into a group of four illuminating units 10 and twelve groups of eight illuminating units 10, wherein within each group of illuminating units 10 they are electrically connected in series, while each group of the illuminating units 10 is electrically connected with each other in parallel.

In order to further enhance the lighting effect of the present invention, for each group of the illuminating units 10, their respective operating circuit can be pre-loaded with a predetermined lighting effect so that all the illuminating units 10 within one particular group flashes or blinks in the same manner.

Furthermore, it is worth stressing that the light string is capable of being conveniently extended by engaging additional flexible connecting links 20 to the last illuminating units 10 of the light string so as to engage with additional illuminating units 10. In other words, the manufacturer of the present invention can be able to, depending on the market condition, decides the length of the light string and produce it accordingly without incurring much additional cost.

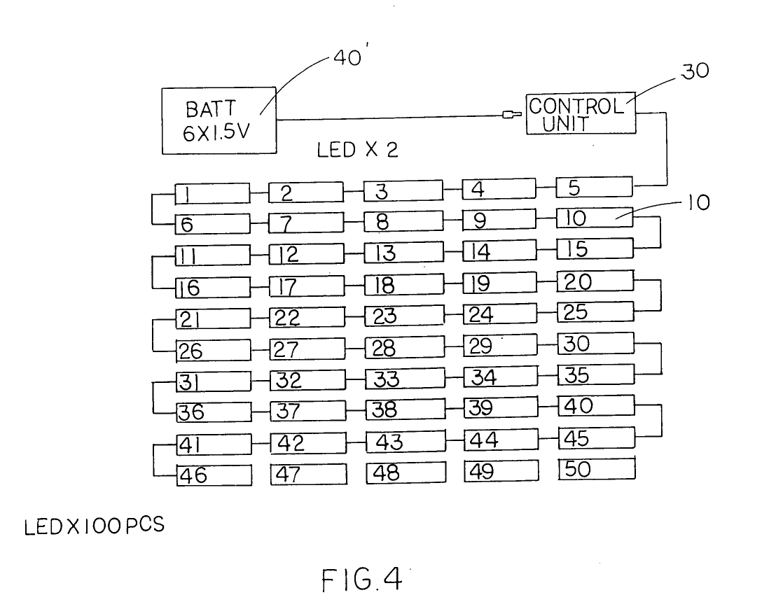

Referring to FIG. 4 of the drawings, an alternative mode of the illuminating light string 1′ of the present invention is illustrated. According to the preferred embodiment, the power device 40′ is embodied as a battery case electrically connected with the control unit 30′ wherein the battery case is adapted to receive a predetermined number of, such as four, DC batteries for providing electric power to the illuminating units 10′.

Moreover, the electrical connections between the illuminating units 10′ are as follows: suppose that there are altogether one hundred illuminators 13′ received in one hundred illuminating units 10′ respectively, they are then divided into fifty groups of two illuminating units 10′ , wherein the fifty groups of such illuminating units 10′ are further divided into 10 classes of 5 groups, and that within each class, the illuminating units groups are electrically connected in series, while each of the classes are electrically connected in parallel.

Obviously, within each class of the illuminating units 10′, the respective operating circuit can be pre-loaded with a predetermined kind of lighting effect so that the illuminators 13′ for a particular class flash or blink in the same fashion.

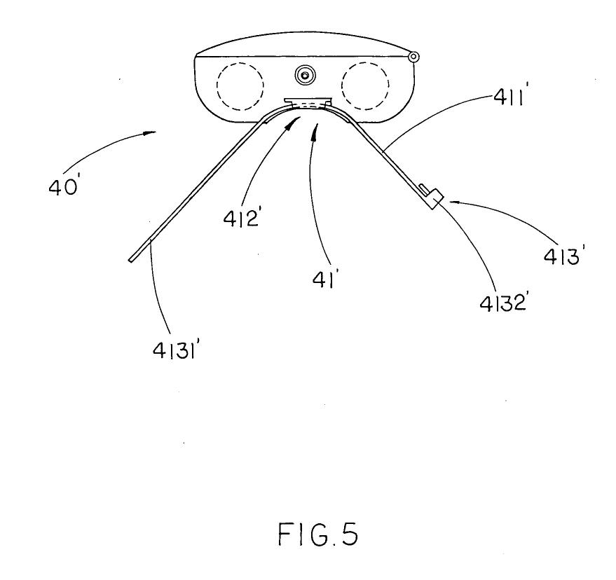

Referring FIG. 5 of the drawings, the power device 40′ further comprises a mounting device 41′ provided at a bottom portion thereof wherein the mounting device 41′ comprises a mounting element 411′, which is embodied as a mounting string, and has a mounting slot 412′ formed on a bottom surface of the power device 40′ wherein the mounting element 411′ is adapted to pass through the mounting slot 412′ for mounting the power device 40′ into an external object, such as a column in a house.

Moreover, the mounting device 41′ further comprises a fastening device 413′ comprising a fastener 4131′ and a fastener holder 4132′, having a fastening slot, provided at two ends of the mounting element 411′ respectively, wherein the fastener 4131′ is adapted to fasten with the fastener holder 4132′ through the fastening slot so as to mount the power device 40′ on an external object.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. An illuminating light string arrangement, comprising:
a plurality of illuminating units, each of which comprises a light housing, a conductive element disposed in said light housing, and an illuminator supported on said light housing to electrically connect with said conductive element;
a plurality of flexible connecting links, each having two conductive ends electrically extended between said two conductive elements of said two illuminating units respectively in such a manner that each of said two illuminating units are electrically linked through said respective connecting link so as to link up said illuminating units in sequence to form a light string; and
a control unit, which is arranged to direct a direct current to said light string, comprising a circuit controlling the illuminating units so as to activate the illuminating units to produce a light effect.

2. The illuminating light string arrangement, as recited in claim 1, wherein each of said light housings has a cavity to receive said conductive element therein and two side engaging slots communicating with said cavity, wherein said illuminator is mounted on said light housing to electrically connect to said conductive element while said two conductive ends of said adjacent connecting links are respectively extended into said light housing through said engaging slots to electrically connect to said conductive element.

3. The illuminating light string arrangement, as recited in claim 2, wherein each of said light housings further comprises an attaching base having a bottom attaching surface for attaching to an external object and an illuminator holder supported on said attaching base to form said cavity therebetween to securely retain said respective illuminator in position.

4. The illuminating light string arrangement, as recited in claim 1, wherein each of said flexible connecting link comprises a flat cable longitudinally extended between each said two adjacent illuminating units to prevent said flexible connecting links from being tangled with each other, wherein electrical wires are received in said flat cable for electrically connecting said two adjacent conductive elements.

5. The illuminating light string arrangement, as recited in claim 2, wherein each of said flexible connecting link comprises a flat cable longitudinally extended between each said two adjacent illuminating units to prevent said flexible connecting links from being tangled with each other, wherein electrical wires are received in said flat cable for electrically connecting said two adjacent conductive elements.

6. The illuminating light string arrangement, as recited in claim 3, wherein each of said flexible connecting link comprises a flat cable longitudinally extended between each said two adjacent illuminating units to prevent said flexible connecting links from being tangled with each other, wherein electrical wires are received in said flat cable for electrically connecting said two adjacent conductive elements.

7. The illuminating light string arrangement, as recited in claim 3, wherein said illuminators are LEDs, having a durable light cover, replaceably mounted on said light housings in a series connecting manner.

8. The illuminating light string arrangement, as recited in claim 6, wherein said illuminators are LEDs, having a durable light cover, replaceably mounted on said light housings in a series connecting manner.

9. The illuminating light string arrangement, as recited in claim 3, wherein said illuminators are LEDs, having a durable light cover, replaceably mounted on said light housings in a parallel connecting manner.

10. The illuminating light string arrangement, as recited in claim 6, wherein said illuminators are LEDs, having a durable light cover, replaceably mounted on said light housings in a parallel connecting manner.

11. The illuminating light string arrangement, as recited in claim 1, wherein said control unit, which is arranged to direct a DC current to said illuminating units, comprises a command circuit electrically connected to said illuminating units to control a manner in which said illuminators illuminate.

12. The illuminating light string arrangement, as recited in claim 8, wherein said control unit, which is arranged to direct a DC current to said illuminating units, comprises a command circuit electrically connected to said illuminating units to control a manner in which said illuminators illuminate.

13. The illuminating light string arrangement, as recited in claim 10, wherein said control unit, which is arranged to direct a DC current to said illuminating units, comprises a command circuit electrically connected to said illuminating units to control a manner in which said illuminators illuminate.

14. The illuminating light string arrangement, as recited in claim 11, wherein each of said conductive elements is an operating circuit electrically connected to said command circuit of said control unit via said flexible connecting ling, wherein said operating circuit regulate and control said respective illuminator to produce said light effect.

15. The illuminating light string arrangement, as recited in claim 12, wherein each of said conductive elements is an operating circuit electrically connected to said command circuit of said control unit via said flexible connecting ling, wherein said operating circuit regulate and control said respective illuminator to produce said light effect.

16. The illuminating light string arrangement, as recited in claim 13, wherein each of said conductive elements is an operating circuit electrically connected to said command circuit of said control unit via said flexible connecting ling, wherein said operating circuit regulate and control said respective illuminator to produce said light effect.

17. The illuminating light string arrangement, as recited in claim 15, further comprising a power device adapted for electrically connecting with an external power source, wherein said power device comprises a AC-DC transformer electrically connecting between the light string and an AC power supply as said external power source so as to convert AC power into DC power to said control unit.

18. The illuminating light string arrangement, as recited in claim 16, further comprising a power device adapted for electrically connecting with an external power source, wherein said power device comprises a AC-DC transformer electrically connecting between the light string and an AC power supply as said external power source so as to convert AC power into DC power to said control unit.

19. The illuminating light string arrangement, as recited in claim 15, further comprising a power device having a battery case for receiving at least a battery therein to electrically connect with said control unit so as to provide DC power to said illuminating units.

20. The illuminating light string arrangement, as recited in claim 16, further comprising a power device having a battery case for receiving at least a battery therein to electrically connect with said control unit so as to provide DC power to said illuminating units.
